(19) United States
(12) Patent Application Publication
(10) Pub. No.: US 2022/0416348 A1
(43) Pub. Date: Dec. 29, 2022

(54) BATTERY HOLDING STRUCTURE

(71) Applicant: TOYOTA JIDOSHA KABUSHIKI KAISHA, Toyota-shi Aichi-ken (JP)

(72) Inventor: Yasuyuki Hihara, Nagoya-shi Aichi-ken (JP)

(73) Assignee: TOYOTA JIDOSHA KABUSHIKI KAISHA, Toyota-shi Aichi-ken (JP)

(21) Appl. No.: 17/843,023

(22) Filed: Jun. 17, 2022

(30) Foreign Application Priority Data
Jun. 23, 2021 (JP) 2021-103896

(51) Int. Cl. H01M 50/244; H01M 50/242; H01M 50/249; H01M 50/264

(52) U.S. Cl. CPC H01M 50/244; H01M 50/242; H01M 50/249; H01M 50/264

(57) ABSTRACT

A battery holding structure includes a battery tray, an upper holding member, and a lower holding member. The battery tray includes a right side wall, a left side wall, a front wall, and a rear wall, and is configured to accommodate a battery such that the bottom end of the battery is securely fastened to the battery tray. The upper holding member and the lower holding member are coupled to surround the battery and the battery tray in a vehicle longitudinal direction. A distance in a vehicle lateral direction between the upper holding member and each of the right and left side walls is shorter than the height of the battery.

### CROSS REFERENCE TO RELATED APPLICATION

This application claims priority to Japanese Patent Application No. 2021-103896 filed on Jun. 23, 2021, which is incorporated herein by reference in its entirety including the specification, claims, drawings, and abstract.

### TECHNICAL FIELD

The present disclosure relates to a battery holding structure mounted on a vehicle.

### BACKGROUND

Vehicles include batteries mounted thereon to supply electrical power to devices. Because batteries are masses that receive considerable inertial forces while vehicles are traveling, batteries must be securely fastened to the vehicles. For example, JP 2016-222167 A discloses a battery holding structure in which a battery is securely fastened on a battery tray.

### SUMMARY

In the battery holding structure disclosed in JP 2016-222167, however, there still is a risk that the battery will be released and come out from the battery tray when a large inertial force acts on the battery while the vehicle is traveling.

In order to address this issue, a holding member which surrounds the battery in a vehicle longitudinal direction may be provided. However, in the case of a side-impact collision, the inertial force of the battery can act in a vehicle lateral direction such that the battery is released and comes out from the battery tray.

An object of the present disclosure is to provide a battery holding structure that can prevent a battery from being released and coming out from a battery tray even when an inertial force of the battery acts in the vehicle lateral direction.

A battery holding structure according to an embodiment of the present disclosure is a structure to hold a battery of a vehicle, and includes a battery tray, and an upper holding member, and a lower holding member. The battery tray includes a right side wall, a left side wall, a front wall, and a rear wall, and is configured to accommodate the battery such that the bottom end of the battery is securely fastened to the battery tray. The upper holding member and the lower holding member are coupled together to surround the battery and the battery tray in a vehicle longitudinal direction. The distance in a vehicle lateral direction between the upper holding member and each of the right and left side walls is shorter than the height of the battery.

A battery holding structure according to an embodiment of the present disclosure can prevent a battery from being released and coming out from a battery tray even when an inertial force acts on the battery in the vehicle lateral direction.

### BRIEF DESCRIPTION OF DRAWINGS

Embodiments of the present disclosure will be described based on the following figures, wherein:

FIG. 1 is a perspective diagram of a battery holding structure according to an embodiment of the present disclosure;

FIG. 2 is a perspective diagram of the battery holding structure of the embodiment shown in FIG. 1, viewed from below;

FIG. 3 is a perspective diagram showing the battery holding structure with the battery removed;

FIG. 4 is a schematic cross section of the battery and a battery tray cut along a lateral direction of the battery holding structure; and

FIG. 5 is a perspective diagram of an upper holding member.

### DESCRIPTION OF EMBODIMENTS

An embodiment of the present disclosure is described below. In the description below, specifics such as shapes, materials, directions, and values are merely examples used to facilitate understanding of the present disclosure. These specifics may be changed as required in accordance with applications, purposes, specifications, or the like.

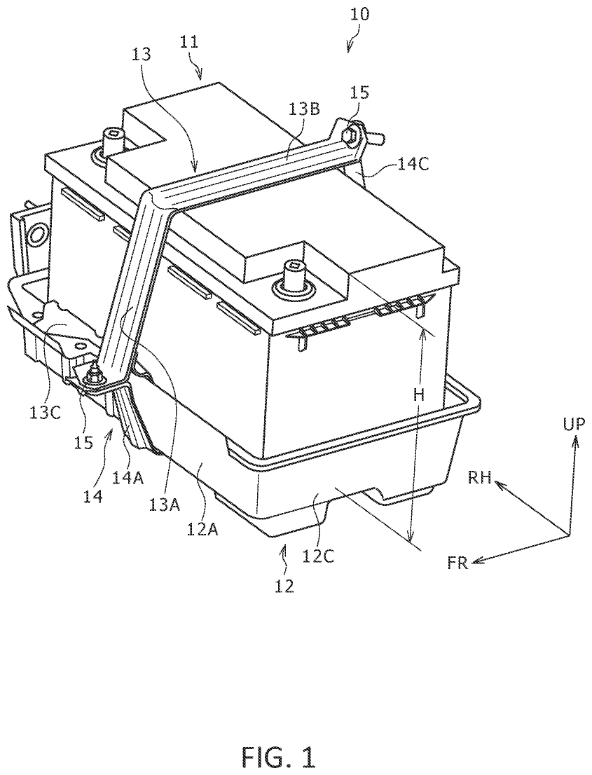

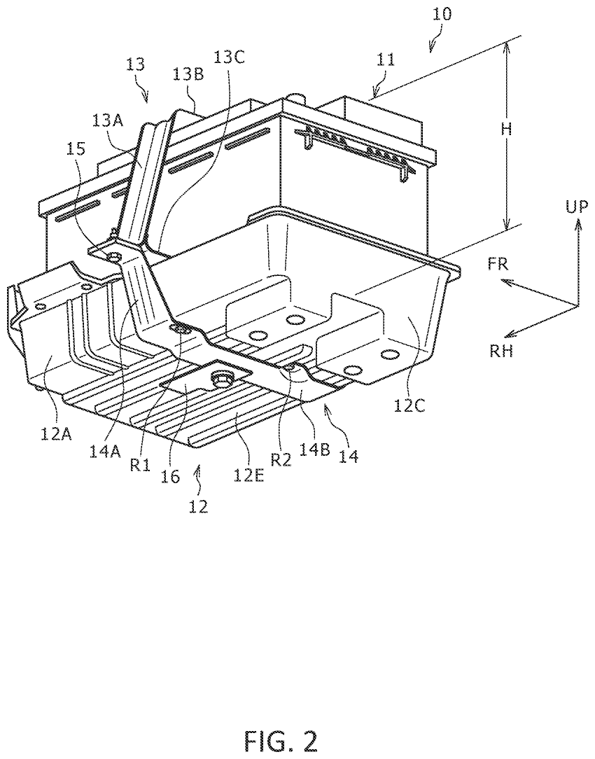

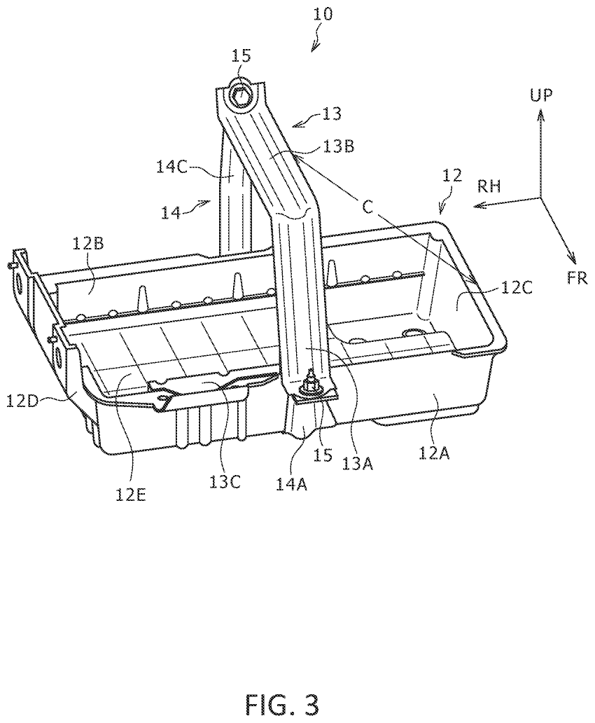

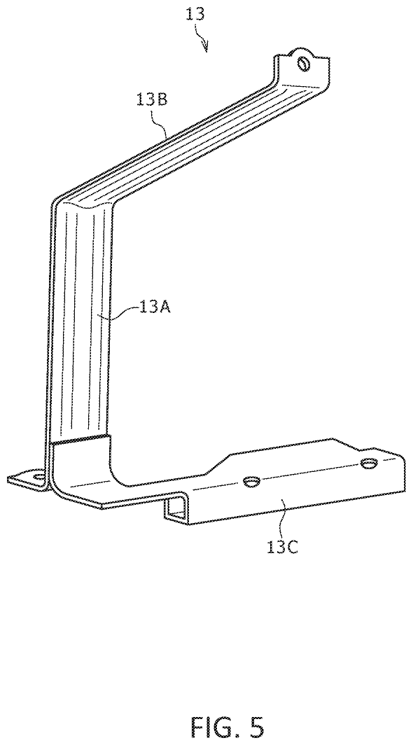

With reference to FIGS. 1 to 5, a battery holding structure 10 according to an embodiment of the present disclosure is described below.

The battery holding structure 10 is a structure to hold a battery 11 of a vehicle. The battery holding structure 10, details of which are described below, can prevent the battery 11 from being released and coming out from a battery tray 12.

Although the vehicle is described as an engine vehicle in the present embodiment, the vehicle is not limited to this embodiment. The vehicle may be of any type as long as the vehicle includes the battery 11, for example, a hybrid vehicle, an electrically-driven vehicle, or a fuel cell vehicle.

The battery 11 may supply electrical power to vehicle electrical components, such as a starter motor used to start the engine, headlamps, stop lamps, audio devices, a navigation system, electrically powered windows, and wipers. The battery 11 may be a battery that supplies electrical power to a traction motor.

Although the battery holding structure 10 according to the present embodiment is disposed in the engine compartment in which the engine is enclosed at the front of the vehicle, the present disclosure is not limited to this embodiment. As long as the battery holding structure 10 is configured to hold the battery 11, the position where the battery holding structure 10 is installed is not limited to any particular locations.

As shown in FIGS. 1 to 3, the battery holding structure 10 includes the battery tray 12 on which the battery 11 is disposed with the bottom end of the battery 11 being securely fastened to the battery tray 12. The battery holding structure 10 also includes an upper holding member 13 and a lower holding member 14 coupled to surround the battery 11 and the battery tray 12.

The battery 11 is substantially a cuboid. In the present embodiment, the battery 11 is oriented with the lateral direction of the battery 11 parallel to the vehicle longitudinal direction (FR direction in the drawings), whereas the longitudinal direction of the battery 11 is parallel to the vehicle lateral direction. The orientation is, however, not limited to this orientation. The battery 11 may also be oriented with the lateral direction of the battery 11 parallel to the vehicle lateral direction (RH direction in the drawings), whereas the longitudinal direction of the battery 11 may be parallel to the vehicle longitudinal direction.

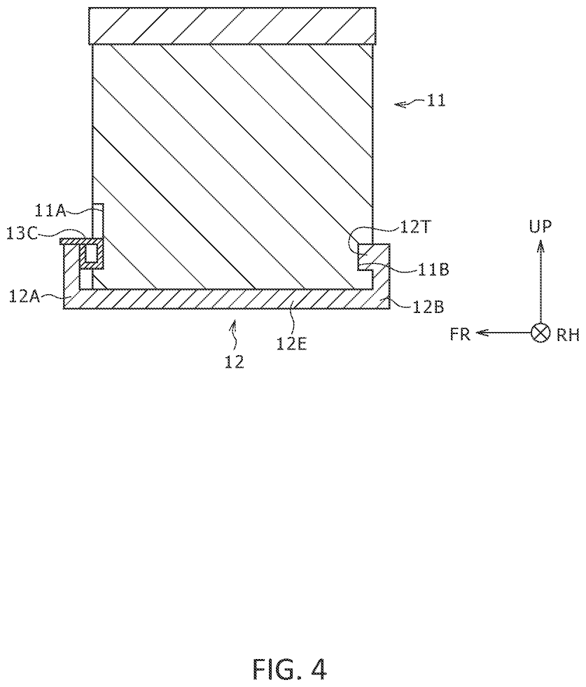

As shown in FIG. 4, the battery 11 is placed on the battery tray 12 such that the bottom end of the battery 11 is securely fastened to the battery tray 12. The structure fastening the battery 11 is described below.

The battery 11 includes recesses 11A, 11B respectively in the longitudinal walls near the bottom. The recess 11A is located on the vehicle front side of the battery 11, whereas the recess 11B is located on the vehicle rear side of the battery 11.

The battery 11 is disposed on the battery tray 12. The battery tray 12 is made of plastic and shaped as a box with an open top. With the battery tray 12, even in case of electrolyte leakage from the battery 11, leaked electrolyte can be collected in the battery tray 12. Further, as described above, the bottom end of the battery 11 can also be securely fastened to the battery tray 12. The battery tray 12 is fixed on the vehicle body.

Specifically, the battery tray 12 includes a front wall 12A, a rear wall 12B, a right side wall 12C (on the vehicle left side), a left side wall 12D (on the vehicle right side), and a bottom 12E. The rear wall 12B includes, on the inner side, a projecting portion 12T that engages in the recess 11B of the battery 11. The lower holding member 14 is fixed to the bottom 12E with a fastener, such as a rivet.

In order to securely fasten the battery 11 on the battery tray 12, the battery 11 is first placed on the battery tray 12 and then slid rearward on the battery tray 12 so that the projecting portion 12T of the battery tray 12 engages in the recess 11B of the battery 11. A battery clamping portion 13C is then engaged into a gap between the front wall 12A of the battery tray 12 and the recess 11A of the battery 11 to fasten the bottom end of the battery 11 to the battery tray 12. The battery clamping portion 13C is unitedly provided with the upper holding member 13 described below.

Returning to FIGS. 1 to 3, the upper holding member 13 is disposed across the top of the battery 11 in the lateral direction of the battery 11 (vehicle longitudinal direction) as described above. The upper holding member 13 can prevent the battery 11 from being released and coming out from the battery tray 12 due to an inertial force of the battery 11 which may likely act in the vehicle longitudinal direction while the vehicle is traveling.

Although the upper holding member 13 is disposed along the lateral direction of the battery 11 (along the vehicle longitudinal direction), the upper holding member 13 is not limited to this orientation. If the battery 11 is orientated with its longitudinal direction in the vehicle longitudinal direction, the upper holding member 13 may be disposed along the longitudinal direction of the battery 11 (along the vehicle longitudinal direction). This can also prevent the battery 11 from being released and coming out from the battery tray 12 due to an inertial force which may likely act in the vehicle longitudinal direction while the vehicle is traveling.

As shown in FIGS. 1, 2, 3, and 5, the upper holding member 13 is made of an elongated metal member which is bent substantially 90 degrees such that a front vertical portion 13A faces the front face of the battery 11 and a horizontal portion 13B faces the top face of the battery 11. The upper holding member 13 includes the battery clamping portion 13C that is welded to the front vertical portion 13A and engages with the battery 11 and the battery tray 12.

The front vertical portion 13A is spaced apart from the front face of the battery 11 by a predetermined gap. The lower end of the front vertical portion 13A is fastened to a front vertical portion 14A of the lower holding member 14 with a fastener 15.

The horizontal portion 13B is spaced apart from the top face of the battery 11 by a predetermined gap. The rear end of the horizontal portion 13B is fastened to a rear vertical portion 14C of the lower holding member 14 with another fastener 15.

As described above, the battery clamping portion 13C engages in a gap between the recess 11A of the battery 11 and the front wall 12A of the battery tray 12. The battery clamping portion 13C is bent to have a predetermined width (dimension in the vehicle longitudinal direction) that matches with the width of the gap. The battery clamping portion 13C extends from the lower end of the front vertical portion 13A along the upper end of the front wall 12A of the battery tray 12.

Together with the engagement of the projecting portion 12T of the battery tray 12 in the recess 11B of the battery 11, the battery clamping portion 13C can fasten the bottom end of the battery 11 to the battery tray 12.

As the battery clamping portion 13C is unitedly provided with the upper holding member 13, the steps required to mount the battery 11 can be simplified in comparison with conventional battery holding structures in which the battery clamp is provided as a separate component.

By using the battery clamping portion 13C that is unitedly provided with the upper holding member 13, fasteners to fasten the battery clamp to the battery tray 12 can be omitted. These fasteners would be required for conventional battery holding structures in which the battery clamp is provided as a separate component.

The distance C in the vehicle lateral direction between the upper holding member 13 and the right side wall 12C of the battery tray 12 is shorter than the height H of the battery 11. More specifically, the distance C is the shortest distance in the vehicle lateral direction between the right edge of the horizontal portion 13B of the upper holding member 13 and the upper edge of the right side wall 12C of the battery tray 12.

Regarding the distance in the vehicle lateral direction between the upper holding member 13 and the left side wall 12D of the battery tray 12, as the upper holding member 13 is disposed substantially at the center in the vehicle lateral direction and the left side wall 12D is higher than the right side wall 12C, when the distance C between the upper holding member 13 and the right side wall 12C of the battery tray 12 is shorter than the height H of the battery 11 as described above, the distance from the left side wall 12D is also shorter than the height H of the battery 11.

The above configuration can prevent the battery 11 from being released and coming out from the battery tray 12 even when an inertial force of the battery 11 acts in the vehicle lateral direction in the case of a side collision, because the distance C between the upper holding member 13 and the right side wall 12C of the battery tray 12 is shorter than the height H of the battery 11.

Returning to FIGS. 1 to 3, the lower holding member 14 is disposed across the bottom of the battery 11 along the lateral direction of the battery 11 (along the vehicle longitudinal direction) and fixed to the vehicle body. Because the lower holding member 14 together with the upper holding member 13 surrounds the battery 11 and is fixed to the vehicle body, the battery 11 can be prevented from being released and coming out from the battery tray 12 due to an inertial force of the battery 11 which may likely act in the vehicle longitudinal direction while the vehicle is traveling.

Although the lower holding member 14 is disposed along the lateral direction of the battery 11 (along the vehicle longitudinal direction), the lower holding member 14 is not limited to this orientation. If the battery is orientated with its longitudinal direction in the vehicle longitudinal direction, the lower holding member 14 may be disposed along the longitudinal direction of the battery 11 (along the vehicle longitudinal direction). This can prevent the battery 11 from being released and coming out from the battery tray 12 due to an inertial force which may likely act in the vehicle longitudinal direction while the vehicle is traveling.

The lower holding member 14 is made of an elongated metal member which is bent substantially 90 degrees twice to form the front vertical portion 14A, a horizontal portion 14B, and the rear vertical portion 14C. The lower holding member 14 is disposed to extend along the outer surface of the battery tray 12.

The front vertical portion 14A is disposed to extend along the outer surface of the front wall 12A of the battery tray 12. As described above, the upper end of the front vertical portion 14A is fastened to the front vertical portion 13A of the upper holding member 13 with the fastener 15.

The horizontal portion 14B is disposed to extend along the outer surface of the bottom 12E of the battery tray 12 and fixed to the bottom 12E with rivets R1, R2. The horizontal portion 14B is fixed to the vehicle body as described above. In the present embodiment, the horizontal portion 14B is fixed, with fasteners, to a bracket 16 that is fixed to a frame of the vehicle body. This can securely fix the upper holding member 13 and the lower holding member 14 to the vehicle body and prevent the battery 11 from being released and coming out from the battery tray 12 due to an inertial force of the battery 11 which acts in the vehicle longitudinal direction.

The rear vertical portion 14C is disposed to extend along the outer surface of the rear wall 12B of the battery tray 12. The upper end of the rear vertical portion 14C is fastened to the rear end of the horizontal portion 13B of the upper holding member 13 with the fastener 15, as described above.

The fasteners 15 couple together the upper holding member 13 and the lower holding member 14. More specifically, one fastener 15 fastens the lower end of the front vertical portion 13A of the upper holding member 13 to the upper end of the front vertical portion 14A of the lower holding member 14. Another fastener 15 fastens the rear end of the horizontal portion 13B of the upper holding member 13 to the upper end of the rear vertical portion 14C of the lower holding member 14. The fasteners 15 may be bolts and nuts.

By coupling together the upper holding member 13 and the lower holding member 14 with the fasteners 15 to surround the battery 11, the battery 11 can be prevented from being displaced in the vehicle longitudinal direction and coming out from the battery tray 12 due to the inertial force of the battery 11 in the vehicle longitudinal direction. The battery 11 can be easily removed from the vehicle (from the battery tray 12) by loosening the fasteners 15 and uncoupling the upper holding member 13 from the lower holding member 14.

The present disclosure is not limited to the above described embodiments or variants of these embodiments. A variety of changes and improvements are possible within the scope of the claims attached hereto.

1. A battery holding structure for holding a battery of a vehicle, the battery holding structure comprising:
a battery tray comprising a right side wall, a left side wall, a front wall, and a rear wall, and being configured to accommodate the battery such that the bottom end of the battery is securely fastened to the battery tray; and
an upper holding member and a lower holding member coupled to surround the battery and the battery tray in a vehicle longitudinal direction,
wherein a distance in a vehicle lateral direction between the upper holding member and each of the right and left side walls is shorter than the height of the battery.
